(19) United States
(12) Patent Application Publication
(10) Pub. No.: US 2018/0086949 A1
(43) Pub. Date: Mar. 29, 2018

(54) CONDUCTIVE PRESSURE-SENSITIVE ADHESIVE TAPE AND METHOD OF PRODUCING CONDUCTIVE PRESSURE-SENSITIVE ADHESIVE TAPE

(71) Applicant: NITTO DENKO CORPORATION, Osaka (JP)

(72) Inventors: Ryo MORIOKA, Ibaraki-shi (JP); Akira HIRAO, Ibaraki-shi (JP); Mitsuhiro KANADA, Ibaraki-shi (JP)

(21) Appl. No.: 15/705,468

(22) Filed: Sep. 15, 2017

(30) Foreign Application Priority Data
Sep. 29, 2016 (JP) 2016-191603

(51) Int. Cl. C09J 9/02; C09J 7/00; C09J 133/08; C09J 11/04

(52) U.S. Cl. CPC C09J 9/02; C09J 7/00; C09J 2433/00; C09J 11/04; C09J 133/08

(57) ABSTRACT

Provided is a conductive pressure-sensitive adhesive tape that achieves both strong adhesion to an adherend and a reworking property. A conductive pressure-sensitive adhesive tape (1) includes a pressure-sensitive adhesive layer (2) containing a pressure-sensitive adhesive resin containing a pressure-sensitive adhesive polymer and conductive particles (4) dispersed in the pressure-sensitive adhesive resin, in which: the pressure-sensitive adhesive layer (2) has a surface layer (22) that is formed of the pressure-sensitive adhesive resin and that forms a surface of the pressure-sensitive adhesive layer; and a thickness of the surface layer (22) includes an analysis depth from the surface of the pressure-sensitive adhesive layer when a spectral intensity derived from the conductive particles in glow discharge spectrometry becomes one half of a maximum thereof, and is 0.1 μm or more and 0.9 μm or less.

This application claims priority under 35 U.S.C. Section 119 to Japanese Patent Application No. 2016-191603 filed on Sep. 29, 2016, which is herein incorporated by references.

### BACKGROUND OF THE INVENTION

### 1. Field of the Invention

The present invention relates to a conductive pressure-sensitive adhesive tape and a method of producing the conductive pressure-sensitive adhesive tape.

### 2. Description of the Related Art

A conductive pressure-sensitive adhesive tape including a pressure-sensitive adhesive layer containing conductive particles, such as metal powder, has been known. This kind of conductive pressure-sensitive adhesive tape has been used in various applications, such as electromagnetic shielding for electrical and electronic equipment, and cables, conduction between two sites distant from each other (e.g., an electrode and a wiring terminal), and grounding for static protection (see, for example, Japanese Patent Application Laid-open No. 2005-54157, Japanese Patent Application Laid-open No. 2009-79127, Japanese Patent Application Laid-open No. 2010-21145, Japanese Patent Application Laid-open No. 2007-211122, and Japanese Patent Translation Publication No. 2008-525579).

In recent years, in association with the downsizing and thinning of electrical and electronic equipment, the narrowing of the bonding area of a conductive pressure-sensitive adhesive tape to be used in such equipment, and the thinning of the tape have been required. However, when an attempt is made to secure the pressure-sensitive adhesive strength of a small conductive pressure-sensitive adhesive tape having a small bonding area to an adherend, the content of conductive particles in the pressure-sensitive adhesive layer of the tape becomes smaller to reduce the conductivity of the tape in some cases. In contrast, when the content of the conductive particles in the pressure-sensitive adhesive layer is increased for securing the conductivity, the pressure-sensitive adhesive strength of the conductive pressure-sensitive adhesive tape reduces or it becomes impossible to form the conductive pressure-sensitive adhesive tape itself in some cases.

Further, a rebonding property may be required in a member in which a conductive pressure-sensitive adhesive tape is used, and hence it has been required that the tape can be peeled without any adhesive residue even after a lapse of time from its bonding. Accordingly, the tape has been required to achieve both strong adhesion to an adherend and a reworking property (rebonding property).

### SUMMARY OF THE INVENTION

An object of the present invention is to provide, for example, a conductive pressure-sensitive adhesive tape that achieves both strong adhesion to an adherend and a reworking property.

The inventors of the present invention have made extensive investigations to achieve the object, and as a result, have found that the following conductive pressure-sensitive adhesive tape achieves both strong adhesion to an adherend and a reworking property, to thereby complete the present invention. The conductive pressure-sensitive adhesive tape includes a pressure-sensitive adhesive layer containing a pressure-sensitive adhesive resin containing a pressure-sensitive adhesive polymer and conductive particles dispersed in the pressure-sensitive adhesive resin, in which: the pressure-sensitive adhesive layer has a surface layer that is formed of the pressure-sensitive adhesive resin and that forms a surface of the pressure-sensitive adhesive layer; and a thickness of the surface layer, which is defined as an analysis depth from the surface of the pressure-sensitive adhesive layer when a spectral intensity derived from the conductive particles in glow discharge spectrometry becomes one half of a maximum thereof, is 0.1 μm or more and 0.9 μm or less.

In the conductive pressure-sensitive adhesive tape, it is preferred that the pressure-sensitive adhesive layer have a thickness of 5 μm or more and 250 μm or less.

In the conductive pressure-sensitive adhesive tape, it is preferred that a volume fraction (vol %) of the conductive particles in the pressure-sensitive adhesive layer be from 10 vol % to 50 vol % .

In the conductive pressure-sensitive adhesive tape, it is preferred that the conductive particles have an average particle diameter of 1 μm or more and 50 μm or less.

In the conductive pressure-sensitive adhesive tape, it is preferred that the pressure-sensitive adhesive polymer include an acrylic polymer.

A method of producing a conductive pressure-sensitive adhesive tape according to another embodiment of the present invention is a method of producing the conductive pressure-sensitive adhesive tape of any one of the foregoing, the method including: applying, in a layered manner, a pressure-sensitive adhesive composition obtained by mixing a syrup composition, which contains monomers for forming the pressure-sensitive adhesive polymer and a partial polymer obtained by polymerizing part of the monomers, and which has a viscosity of from 10 Pa·s to 30 Pa·s, a photopolymerization initiator, and the conductive particles; and irradiating both surface sides of the layered pressure-sensitive adhesive composition with an active energy ray to cure the pressure-sensitive adhesive composition to provide a pressure-sensitive adhesive layer.

In the method of producing the conductive pressure-sensitive adhesive tape, it is preferred that in the irradiating step, the active energy ray be formed of UV light and the active energy ray has an irradiance of from 1 mW/cm² to 10 mW/cm².

According to the present invention, for example, the conductive pressure-sensitive adhesive tape that achieves both strong adhesion to an adherend and a reworking property can be provided.

### BRIEF DESCRIPTION OF THE DRAWINGS

FIG. 1 is a schematic view of a pressure-sensitive adhesive tape formed only of a pressure-sensitive adhesive layer.

FIG. 2 is a schematic view of a pressure-sensitive adhesive tape in which a pressure-sensitive adhesive layer is formed on each of both surfaces of a base material.

FIG. 3 is a schematic view of a pressure-sensitive adhesive tape in which a pressure-sensitive adhesive layer is formed on one surface of a base material.

FIG. 4 is an explanatory view for schematically illustrating a sectional SEM image of a conductive particle to be used in the calculation of the true density of the conductive particle.

FIG. 5 is an explanatory view for schematically illustrating a step of irradiating both surface sides of a layered pressure-sensitive adhesive composition with UV light to cure the pressure-sensitive adhesive composition.

FIG. 6 is an explanatory view for schematically illustrating a method of measuring a resistance value (Z-axis direction).

FIG. 7 is a graph for showing a relationship obtained by GDS between the Ag spectral intensity (cps) and analysis depth (μm) of a pressure-sensitive adhesive tape of Example 4.

### DESCRIPTION OF THE EMBODIMENTS

A conductive pressure-sensitive adhesive tape according to this embodiment includes a pressure-sensitive adhesive layer containing a pressure-sensitive adhesive resin containing a pressure-sensitive adhesive polymer and conductive particles dispersed in the pressure-sensitive adhesive resin. In particular, the pressure-sensitive adhesive layer has a surface layer (skin layer) that is formed of the pressure-sensitive adhesive resin and that forms a surface of the pressure-sensitive adhesive layer. The surface layer is arranged on each of both surface sides of a layered main body layer arranged on the center side of the pressure-sensitive adhesive layer. The surface layer and the main body layer are integrally formed with each other, and no joint is present between the surface layer and the main body layer.

Although the “conductive pressure-sensitive adhesive tape” is generally called by a different name, such as “conductive pressure-sensitive adhesive sheet” or “conductive pressure-sensitive adhesive film,” in some cases, the unified expression “conductive pressure-sensitive adhesive tape” is used herein. In addition, a surface (i.e., a surface of a surface layer) of a pressure-sensitive adhesive layer in a conductive pressure-sensitive adhesive tape is sometimes referred to as “pressure-sensitive adhesive surface.”

The conductive pressure-sensitive adhesive tape of this embodiment may be a double-sided pressure-sensitive adhesive tape in which both surfaces of the tape serve as pressure-sensitive adhesive surfaces, or may be a single-sided pressure-sensitive adhesive tape in which only one surface of the tape serves as a pressure-sensitive adhesive surface.

The conductive double-sided pressure-sensitive adhesive tape may be a so-called base material-less conductive double-sided pressure-sensitive adhesive tape that does not include a base material, such as a metal foil, or may be a so-called conductive double-sided pressure-sensitive adhesive tape with a base material that includes the base material.

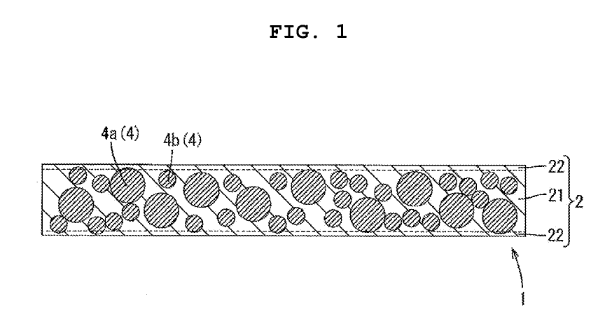

The base material-less conductive double-sided pressure-sensitive adhesive tape is, for example, a conductive pressure-sensitive adhesive tape 1 formed only of a pressure-sensitive adhesive layer 2 as illustrated in FIG. 1. The pressure-sensitive adhesive layer 2 includes a main body layer 21 arranged on its center side, and surface layers 22, 22 arranged on both outer sides of the main body layer 21. The surface layer 22 on one side and the surface layer 22 on the other side are identical to each other in thickness. In addition, the thickness of each of the surface layers 22 is smaller than the thickness of the main body layer 21, and is set within such a predetermined thickness range as described later.

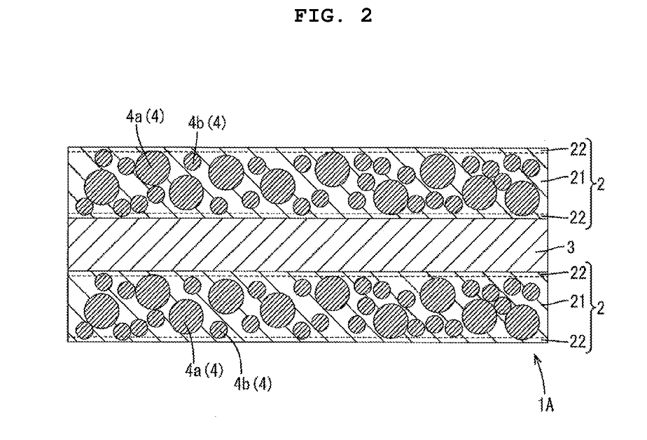

In addition, the conductive double-sided pressure-sensitive adhesive tape with a base material is, for example, a conductive pressure-sensitive adhesive tape 1A in which the pressure-sensitive adhesive layer 2 is formed on each of both surfaces of a conductive base material (an example of a base material) 3 as illustrated in FIG. 2. The conductive pressure-sensitive adhesive tape 1A has the two pressure-sensitive adhesive layers 2. In each of the pressure-sensitive adhesive layers 2, the surface layer 22 on one side forms the pressure-sensitive adhesive surface of the pressure-sensitive adhesive layer 2, and the surface layer 22 on the other side is in close contact with the conductive base material 3 supporting the pressure-sensitive adhesive layer 2.

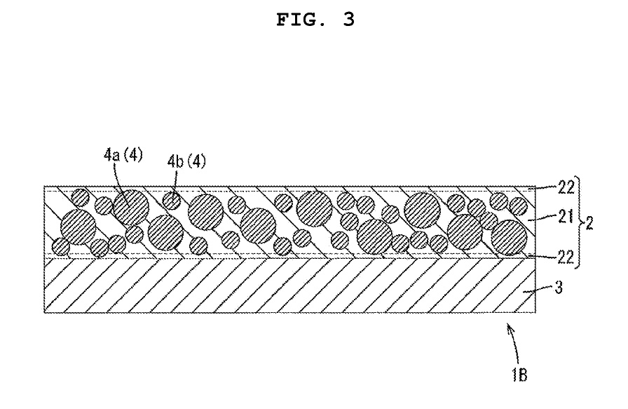

In addition, the conductive single-sided pressure-sensitive adhesive tape is, for example, a conductive pressure-sensitive adhesive tape 1B in which the pressure-sensitive adhesive layer 2 is formed on one surface of the conductive base material (an example of a base material) 3, such as a metal foil, as illustrated in FIG. 3. The conductive pressure-sensitive adhesive tape 1B has the one pressure-sensitive adhesive layer 2. The surface layer 22 on one side of the pressure-sensitive adhesive layer 2 forms a pressure-sensitive adhesive surface, and the surface layer 22 on the other side thereof is in close contact with the conductive base material 3 supporting the pressure-sensitive adhesive layer 2.In each of FIGS. 1 to 3, conductive particles 4 (large-diameter conductive particles 4a and small-diameter conductive particles 4b) in the pressure-sensitive adhesive layer 2 are schematically illustrated. The conductive particles 4 are present mainly in the main body layer 21 of the pressure-sensitive adhesive layer 2.

The conductive pressure-sensitive adhesive tape of this embodiment may include any other layer (e.g., an intermediate layer or an undercoat layer) in addition to the base material and the pressure-sensitive adhesive layer to the extent that the object of the present invention is not impaired.

[Pressure-Sensitive Adhesive Layer]

The pressure-sensitive adhesive layer is a layer having conductivity (electrical conductivity) while providing a pressure-sensitive adhesive surface of the conductive pressure-sensitive adhesive tape. The bonding of the pressure-sensitive adhesive surface of the pressure-sensitive adhesive layer to an adherend, such as a conductor, secures electrical conduction between the adherend and the pressure-sensitive adhesive layer.

As described above, the pressure-sensitive adhesive layer includes a main body layer on its center side and a surface layer arranged on each of both outer sides of the main body layer. The entirety of the pressure-sensitive adhesive layer contains at least a pressure-sensitive adhesive resin containing a pressure-sensitive adhesive polymer and conductive particles dispersed in the pressure-sensitive adhesive resin. The surface layer is formed mainly of the pressure-sensitive adhesive resin containing the pressure-sensitive adhesive polymer, and is formed integrally with the main body layer. In contrast, the main body layer includes the pressure-sensitive adhesive resin containing the pressure-sensitive adhesive polymer and the conductive particles dispersed in the pressure-sensitive adhesive resin. The conductive particles are present mainly in the pressure-sensitive adhesive main body layer out of the pressure-sensitive adhesive layer. The surface layer and main body layer of such pressure-sensitive adhesive layer may each contain any other component (additive) to the extent that the object of the present invention is not impaired. The pressure-sensitive adhesive resin, the conductive particles, and the like to be utilized in the pressure-sensitive adhesive layer are described below.

(Pressure-Sensitive Adhesive Resin)

The pressure-sensitive adhesive resin is a component for, for example, securing the pressure-sensitive adhesive strength of the pressure-sensitive adhesive layer, and contains a pressure-sensitive adhesive polymer. Examples of the pressure-sensitive adhesive polymer include an acrylic polymer, a silicone-based polymer, a urethane-based polymer, a rubber-based polymer, a vinyl alkyl ether-based polymer, a polyester-based polymer, a polyamide-based polymer, a fluorine-based polymer, and an epoxy-based polymer. Of those, an acrylic polymer is preferably used from the viewpoints of, for example, the ease with which the polymer is designed, the ease with which the pressure-sensitive adhesive strength is adjusted, and the securement of dispersibility of the conductive particles. The pressure-sensitive adhesive polymers may be used alone or in combination thereof.

The content of the pressure-sensitive adhesive resin is preferably 20 mass % or more, more preferably 25 mass % or more, still more preferably 30 mass % or more with respect to the total mass (100 mass %) of the pressure-sensitive adhesive layer, and is preferably 60 mass % or less, more preferably 55 mass % or less with respect thereto.

In addition, the content of the acrylic polymer is preferably 80 mass % or more, more preferably 85 mass % or more with respect to the total mass (100 mass %) of the pressure-sensitive adhesive resin, and is preferably 100 mass % or less, more preferably 90 mass % or less with respect thereto.

The acrylic polymer is not particularly limited, and for example, preferably contains at least a constituent unit derived from a (meth)acrylic acid alkyl ester having a linear or branched alkyl group having 1 to 20 carbon atoms (hereinafter simply referred to as “(meth)acrylic acid alkyl ester”) and a constituent unit derived from a polar group-containing monomer. The term “(meth)acrylic” as used herein refers to “acrylic” and/or “methacrylic” (one or both of “acrylic” and “methacrylic”).

Examples of the (meth)acrylic acid alkyl ester include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate, t-pentyl (meth)acrylate, neopentyl (meth)acrylate, isohexyl (meth)acrylate, isoheptyl (meth)acrylate, 2-propylheptyl (meth)acrylate, isoundecyl (meth)acrylate, isododecyl (meth)acrylate, isomyristyl (meth)acrylate, isopentadecyl (meth)acrylate, isohexadecyl (meth)acrylate, isoheptadecyl (meth)acrylate, and isostearyl (meth)acrylate. Such (meth)acrylic acid alkyl esters may be used alone or in combination thereof.

The (meth)acrylic acid alkyl ester is preferably a (meth)acrylic acid alkyl ester having an alkyl group having 4 to 12 carbon atoms, more preferably a (meth)acrylic acid alkyl ester having an alkyl group having 4 to 8 carbon atoms. Preferred specific examples thereof include n-butyl (meth)acrylate and 2-ethylhexyl (meth)acrylate.

The content of the (meth)acrylic acid alkyl ester is preferably 50 mass % or more, more preferably 55 mass % or more, still more preferably 60 mass % or more with respect to the total amount (100 mass %) of the monomer components forming the acrylic polymer, and is preferably 99 mass % or less, more preferably 98 mass % or less, still more preferably 97 mass % or less with respect thereto.

The polar group-containing monomer has at least one kind of polar group, and is formed of a monomer containing a polymerizable unsaturated bond. Examples of the polar group-containing monomer include: carboxyl group-containing monomers, such as (meth)acrylic acid, itaconic acid, maleic acid, fumaric acid, crotonic acid, and isocrotonic acid (including acid anhydride group-containing monomers, such as maleic anhydride and itaconic anhydride); hydroxyl group (hydroxy group)-containing monomers, such as hydroxyalkyl (meth)acrylates, for example, 2-hydroxyethyl (meth)acrylate, 3-hydroxypropyl (meth)acrylate, 4-hydroxybutyl (meth)acrylate, and 6-hydroxyhexyl (meth)acrylate, vinyl alcohol, and allyl alcohol; amide group-containing monomers, such as (meth)acrylamide, N,N-dimethyl(meth)acrylamide, N-methylol(meth)acrylamide, N-methoxymethyl(meth)acrylamide, N-butoxymethyl(meth)acrylamide, and N-hydroxyethylacrylamide; amino group-containing monomers, such as aminoethyl (meth)acrylate, dimethylaminoethyl (meth)acrylate, and t-butylaminoethyl (meth)acrylate; glycidyl group-containing monomers, such as glycidyl (meth)acrylate and methylglycidyl (meth)acrylate; cyano group-containing monomers, such as acrylonitrile and methacrylonitrile; heterocyclic ring-containing vinyl-based monomers, such as N-vinyl-2-pyrrolidone, (meth)acryloylmorpholine, N-vinylpiperidone, N-vinylpiperazine, N-vinylpyrrole, and N-vinylimidazole; alkoxyalkyl (meth)acrylate-based monomers, such as methoxyethyl (meth)acrylate and ethoxyethyl (meth)acrylate; sulfonic acid group-containing monomers, such as sodium vinylsulfonate; phosphoric acid group-containing monomers, such as 2-hydroxyethylacryloyl phosphate; imide group-containing monomers, such as cyclohexylmaleimide and isopropylmaleimide; and isocyanate group-containing monomers, such as 2-methacryloyloxyethyl isocyanate. Those polar group-containing monomers may be used alone or in combination thereof.

The polar group-containing monomer is preferably a carboxyl group-containing monomer or a heterocyclic ring-containing vinyl-based monomer. The carboxyl group-containing monomer is preferably acrylic acid, and the heterocyclic ring-containing vinyl-based monomer is preferably N-vinyl-2-pyrrolidone.

The content of the polar group-containing monomer is preferably 0.1 mass % or more, more preferably 1 mass % or more with respect to the total amount (100 mass %) of the monomer components forming the acrylic polymer, and is preferably 20 mass % or less, more preferably 10 mass % or less with respect thereto.

The acrylic polymer may contain, in addition to the (meth)acrylic acid alkyl ester and the polar group-containing monomer, a constituent unit derived from any other copolymerizable monomer, such as a polyfunctional monomer, as required.

The polyfunctional monomer includes a monomer having two or more polymerizable functional groups. Examples of the polyfunctional monomer include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, and urethane acrylate. Those polyfunctional monomers may be used alone or in combination thereof.

The content of the polyfunctional monomer is preferably 0.001 mass % or more, more preferably 0.01 mass % or more with respect to the total amount (100 mass %) of the monomer components forming the acrylic polymer, and is preferably 0.5 mass % or less, more preferably 0.3 mass % or less with respect thereto. When the content of the polyfunctional monomer falls within such range, the cohesive strength of the pressure-sensitive adhesive layer does not become excessively high and its pressure-sensitive adhesive strength can be improved.

The other copolymerizable monomer except the polyfunctional monomer is not particularly limited, and examples thereof include: (meth)acrylic acid alkoxyalkyl esters, such as 2-methoxyethyl (meth)acrylate, 2-ethoxyethyl (meth)acrylate, methoxytriethylene glycol (meth)acrylate, 3-methoxypropyl (meth)acrylate, 3-ethoxypropyl (meth)acrylate, 4-methoxybutyl (meth)acrylate, and 4-ethoxybutyl (meth)acrylate; (meth)acrylic acid esters each having an alicyclic hydrocarbon group, such as cyclopentyl (meth)acrylate, cyclohexyl (meth)acrylate, and isobornyl (meth)acrylate; (meth)acrylic acid aryl esters, such as phenyl (meth)acrylate; vinyl esters, such as vinyl acetate and vinyl propionate; aromatic vinyl compounds, such as styrene and vinyltoluene; olefins or dienes, such as ethylene, butadiene, isoprene, and isobutylene; vinyl ethers, such as a vinyl alkyl ether; and vinyl chloride. Those monomers may be used alone or in combination thereof.

Examples of the polymerization method for the pressure-sensitive adhesive polymer, such as the acrylic polymer, include a solution polymerization method, an emulsion polymerization method, a bulk polymerization method, and a photopolymerization method. Of those, a photocuring reaction based on an active energy ray (e.g., UV light) involving using a photopolymerization initiator is preferably utilized at the time of the preparation of the pressure-sensitive adhesive polymer from the viewpoints of, for example, the dispersibility of the conductive particles and the shortening of a polymerization time. As described later, the pressure-sensitive adhesive polymer is particularly preferably prepared by using a solventless-type pressure-sensitive adhesive composition blended with the photopolymerization initiator.

The polymerization initiators, such as the photopolymerization initiator, to be utilized in the preparation of the pressure-sensitive adhesive polymer may be used alone or in combination thereof.

Examples of the photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzil-based photopolymerization initiator, a benzophenone-based photopolymerization initiator, a ketal-based photopolymerization initiator, a thioxanthone-based photopolymerization initiator, and an acylphosphine oxide-based photopolymerization initiator.

Examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (manufactured by BASF, product name: IRGACURE 651), and anisole methyl ether. Examples of the acetophenone-based photopolymerization initiator include 1-hydroxycyclohexyl phenyl ketone (manufactured by BASF, product name: IRGACURE 184), 4-phenoxydichloroacetophenone, 4-t-butyl-dichloroacetophenone, 1-[4-(2-hydroxyethoxy)-phenyl]-2-hydroxy-2-methyl-1-propan-1-on e (manufactured by BASF, product name: IRGACURE 2959), 2-hydroxy-2-methyl-1-phenyl-propan-1-one (manufactured by BASF, product name: DAROCUR 1173), and methoxyacetophenone. Examples of the α-ketol-based photopolymerization initiator include 2-methyl-2-hydroxypropiophenone and 1-[4-(2-hydroxyethyl)-phenyl]-2-hydroxy-2-methylpropan-1-one.

An example of the aromatic sulfonyl chloride-based photopolymerization initiator is 2-naphthalenesulfonyl chloride. An example of the photoactive oxime-based photopolymerization initiator is 1-phenyl-1,1-propanedione-2-(o-ethoxycarbonyl)-oxime. An example of the benzoin-based photopolymerization initiator is benzoin. An example of the benzil-based photopolymerization initiator is benzil. Examples of the benzophenone-based photopolymerization initiator include benzophenone, benzoylbenzoic acid, 3,3′-dimethyl-4-methoxybenzophenone, polyvinylbenzophenone, and a-hydroxycyclohexyl phenyl ketone. An example of the ketal-based photopolymerization initiator is benzyl dimethyl ketal. Examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and dodecylthioxanthone.

Examples of the acylphosphine oxide-based photopolymerization initiator include bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropan-1-yl)phosphine oxide, bis(2-methoxybenzoyl)(1-methylpropan-1-yl)phosphine oxide, bis(2,6-diethoxybenzoyl)(2-methylpropan-1-yl)phosphine oxide, bis(2,6-diethoxybenzoyl)(1-methylpropan-1-yl)phosphine oxide, bis(2,6-dibutoxybenzoyl)(2-methylpropan-1-yl)phosphine oxide, bis(2,4-dimethoxybenzoyl)(2-methylpropan-1-yl)phosphine oxide, bis(2,4,6-trimethylbenzoyl)(2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphineoxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide.

Although the usage amount of the photopolymerization initiator is not particularly limited as long as the object of the present invention is not impaired, for example, the usage amount is preferably 0.01 part by mass or more, more preferably 0.03 part by mass or more, still more preferably 0.05 part by mass or more with respect to 100 parts by mass of the amount of all monomers to be utilized for forming the pressure-sensitive adhesive polymer, and is preferably 5 parts by mass or less, more preferably 3 parts by mass or less, still more preferably 2 parts by mass or less with respect thereto. When the usage amount of the photopolymerization initiator falls within such range, the polymerization reaction can be sufficiently performed, and hence a reduction in molecular weight of the polymer to be produced can be suppressed.

An active energy ray is utilized at the time of the activation of the photopolymerization initiator. Examples of such active energy ray include: ionizing radiations, such as an α-ray, a β-ray, a γ-ray, a neutron beam, and an electron beam; and UV light. Of those, UV light is particularly suitable.

(Conductive Particles)

Particles each having conductivity, such as metal powder, are utilized as the conductive particles. Examples of materials to be utilized in the conductive particles include conductive materials including: metals, such as nickel, iron, chromium, cobalt, aluminum, antimony, molybdenum, copper, silver, platinum, and gold; alloys, such as solder and stainless steel; metal oxides; and carbon, such as carbon black. The conductive particles may be particles (powder) each formed of any such conductive material as described in the foregoing, or may be metal-coated particles obtained by coating the surfaces of particles, such as polymer particles, glass particles, or ceramic particles, with a metal. In addition, particles obtained by coating the surfaces of metal particles with any other metal may be used as the conductive particles.

The shapes of the conductive particles include various shapes, such as a spherical shape, a flake shape (thin section shape), a spike shape (burr-like shape), and a filament shape, and are appropriately selected from known shapes. The shapes of the conductive particles are preferably spherical shapes from the viewpoints of, for example, the securement of a pressure-sensitive adhesive strength and the ease with which the conductive particles form a conductive path in the pressure-sensitive adhesive layer.

The true density of each of the conductive particles is preferably more than 0 g/cm³ and less than 8 g/cm³. The use of such low-density particles as described above is suitable for maintaining a state in which the conductive particles are suspended while maintaining a substantially uniform distribution by at least the time the pressure-sensitive adhesive composition is cured to provide a stable pressure-sensitive adhesive layer. For example, when the conductive particles are formed only of a conductive material, the specific gravity of the conductive material is the true density. In contrast, when a metal coating is formed on the surface of each of nonconductive particles like the above-mentioned metal-coated particles, the true density of each of the conductive particles is determined by the following method. When the true density of each of the conductive particles cannot be measured by the following method, the true density only needs to be measured by appropriately using a conventionally known method of measuring a true density.

Here, description is given by taking conductive particles obtained by coating the surface of a spherical glass bead (glass layer) 41 with silver (silver coating layer) 42 (conductive particles formed of so-called silver-coated glass particles) as an example of the conductive particles 4. The true density of each of the conductive particles 4 is calculated by using measured values obtained by: taking an image of the conductive particle 4 with a scanning electron microscope (SEM); and measuring the particle diameter (radius R) of the conductive particle 4,a thickness T of the silver coating layer 42, the particle diameter (radius r) of the glass layer 41, and the like from the resultant image (sectional SEM image). A method of calculating the true density is described in more detail below.

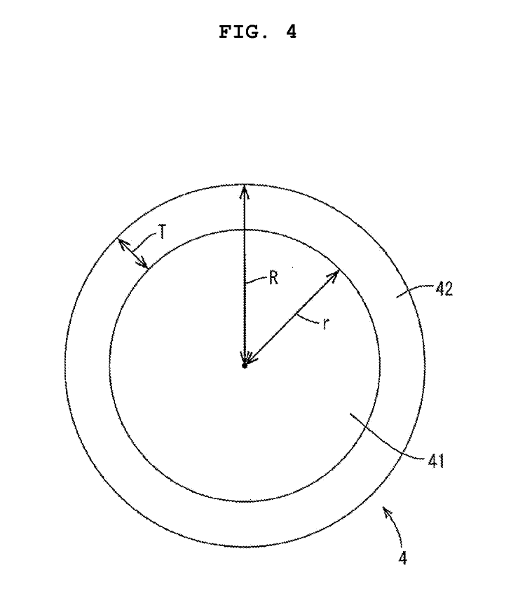

Here, description is given of taking the image of the conductive particle 4 with the SEM. FIG. 4 is an explanatory view for schematically illustrating the sectional SEM image of the conductive particle 4 to be used in the calculation of the true density of the conductive particle 4. Before the image of the conductive particle 4 is taken with the SEM, the adjustment of the conductive particle 4 serving as a sample is performed in advance. Specifically, the conductive particle 4 is stained with a heavy metal (heavy metal staining), and the stained conductive particle 4 is subjected to ion milling processing and further subjected to a conductive treatment. The conductive particle 4 adjusted as described above is observed (imaged) with the SEM. A section of the conductive particle 4 is shown in the resultant SEM image.

For example, a product available under the product name “S-4800” from Hitachi, Ltd. may be used as the analyzer (SEM). In addition, the measurement conditions of the analyzer (SEM) are as follows: an observation image is a backscattered electron image and an acceleration voltage is 10 kV.

The thickness T of the silver coating layer 42 is measured by using the resultant sectional SEM image of the conductive particle 4. Next, a volume v 2 of the silver coating layer 42 per one conductive particle 4 and a mass m 2 of the silver coating layer 42 per one conductive particle 4 are calculated by using the resultant thickness T (measured value) of the silver coating layer 42. At the time of the calculation, the specific gravity of silver (general literature value: 10 g/cm³) is used.

In addition, the particle diameter (radius r) of the glass layer 41 is measured by using the resultant sectional SEM image of the conductive particle 4. Next, a volume v1 of the glass layer 41 per one conductive particle 4 and a mass m1 of the glass layer 41 per one conductive particle 4 are calculated by using the resultant particle diameter (radius r, measured value) of the glass layer 41. At the time of the calculation, the specific gravity of glass (general literature value: 2.5 g/cm³) is used.

The particle diameter (radius r) of the glass layer 41 may be calculated from a measured value for the particle diameter (radius R) of the conductive particle 4 and the measured value for the thickness T of the silver coating layer 42.

The true density of the conductive particle 4 is calculated from the following equation by using the respective values v1 v2, m1 and m2 calculated as described above. True density=(m1+m2)/(v1+v2)

Also in the case of a hollow conductive particle (e.g., a conductive particle in which the glass layer 41 is hollow), its true density may be determined by the above-mentioned calculation method.

In addition, the particle size distribution curve (particle diameter range, peak top, and the like) of the conductive particles in the pressure-sensitive adhesive layer is determined in accordance with, for example, the following procedure.

First, the pressure-sensitive adhesive layer of the conductive pressure-sensitive adhesive tape is baked, and the conductive particles are extracted from the layer. A SEM image of the extracted conductive particles is taken (at a magnification of, for example, 600 times), and the SEM image is subjected to computer image analysis with image analysis software (A-ZO KUN (trademark), manufactured by Asahi Kasei Engineering Corporation). Thus, particle information (particle diameter and the like) on the conductive particles in the SEM image is acquired.

Although setting conditions for the image analysis (circular particle analysis) are not particularly limited, the analysis is performed under, for example, the following conditions: reduced scale value at the time of image transfer: 0.178571; brightness of a particle: bright; extraction method: automatic or manual; processing speed: high speed; noise-removing filter: present; unit in which a result is displayed: μm; range of diameters to be measured: 2 μm to 70 μm; circularity threshold: 10; and overlapping degree: 90. In addition, when a portion that is not particulate or a product in which particles adhere to each other is counted as one particle in analysis results, the particle diameter of each particle is determined by appropriately adding or deleting a particle through manual correction.

Such analysis as described above is performed at each of different positions of the SEM image a plurality of times (e.g., a total of 10 times), and the particle size distribution curve (particle diameter range, peak top, and the like) of the conductive particles is determined from the average of the results.

The particle size distribution curve of the conductive particles is determined by such image analysis as described above not only when the shape of each of the conductive particles is a spherical shape but also when the shape is a shape except a spherical shape.

In this embodiment, for example, the particle diameter range of the conductive particles starts from preferably 1 μm or more, more preferably 5 μm or more, still more preferably 10 μm or more, and ends on preferably 50 μm or less, more preferably 40 μm or less, still more preferably 35 μm or less. When the particle diameter range of the conductive particles is such range, the functions, such as conductivity, of the pressure-sensitive adhesive layer can be secured without any reduction in pressure-sensitive adhesive strength of the pressure-sensitive adhesive layer.

In addition, the particle size distribution curve of the conductive particles may be, for example, a curve having at least one peak top in the particle diameter range of from 15 μm or more to 50 μm or less, and having at least one peak top in the particle diameter range of from 1 μm or more to 12 μm or less.

In this embodiment, the conductive particles are dispersed in the main body layer on the center side of the pressure-sensitive adhesive layer in a substantially uniform manner. Accordingly, as described later, the pressure-sensitive adhesive layer of the conductive pressure-sensitive adhesive tape of this embodiment secures a sufficient pressure-sensitive adhesive strength and a sufficient function, such as conductivity.

The volume fraction (vol %) of the conductive particles in the pressure-sensitive adhesive layer is preferably 10 vol % or more, more preferably 20 vol % or more, still more preferably 30 vol % or more, and is preferably 70 vol % or less, more preferably 60 vol % or less, still more preferably 50 vol % or less. When the volume fraction (vol %) of the conductive particles in the pressure-sensitive adhesive layer falls within such range, the conductivity of the pressure-sensitive adhesive layer is easily secured and the thickness of each surface layer of the pressure-sensitive adhesive layer is easily regulated within a predetermined range.

When the volume fraction of the conductive particles is high, the dispersibility of the conductive particles in the pressure-sensitive adhesive layer reduces, and hence the thickness of each surface layer (skin layer) becomes smaller. In contrast, when the volume fraction of the conductive particles is low, the dispersibility of the conductive particles in the pressure-sensitive adhesive layer is raised, and hence the thickness of each surface layer (skin layer) becomes larger. In addition, when the volume fraction of the conductive particles is low, the content of the conductive particles reduces, and hence the conductivity reduces.

In addition, although the content of the conductive particles in the pressure-sensitive adhesive layer is not particularly limited as long as the volume fraction of the conductive particles falls within the above-mentioned range, for example, the content is preferably 80 mass % or less, more preferably 75 mass % or less, still more preferably 70 mass % or less, and is preferably 40 mass % or more, more preferably 45 mass % or more.

In this specification, for convenience of description, conductive particles formed of a group of particles each having a particle diameter in the range of from 15 μm or more to 50 μm or less may be referred to as “large-diameter conductive particles,” and conductive particles formed of a group of particles each having a particle diameter in the range of from 1 μm or more to 12 μm or less may be referred to as “small-diameter conductive particles.”

In addition, the pressure-sensitive adhesive layer may contain various tackifying resins, such as a hydrogenated tackifying resin, to the extent that the object of the invention of the present application is not impaired. For example, hydrogenated derivatives of tackifying resins, such as a petroleum-based resin, a terpene-based resin, a coumarone/indene-based resin, a styrene-based resin, a rosin-based resin, an alkylphenol resin, and a xylene resin, may each be used as the hydrogenated tackifying resin. For example, a hydrogenated petroleum-based resin is appropriately selected from aromatic-based, dicyclopentadiene-based, aliphatic-based, and aromatic-dicyclopentadiene copolymer-based resins and the like. In addition, a hydrogenated terpene-based resin is appropriately selected from a terpene phenol resin, an aromatic terpene resin, and the like. Those resins may be used alone or in combination thereof.

In addition, the pressure-sensitive adhesive layer may contain a cross-linking agent to the extent that the object of the invention of the present application is not impaired. The cross-linking agent may be utilized for the purpose of, for example, adjusting the cohesive strength of the pressure-sensitive adhesive layer. Examples of the cross-linking agent may include an epoxy-based cross-linking agent, an isocyanate-based cross-linking agent, a silicone-based cross-linking agent, an oxazoline-based cross-linking agent, an aziridine-based cross-linking agent, a silane-based cross-linking agent, an alkyl-etherified melamine-based cross-linking agent, and a metal chelate-based cross-linking agent. Those cross-linking agents may be used alone or in combination thereof.

In addition, the pressure-sensitive adhesive layer may contain, for example, a cross-linking promoter, a silane coupling agent, an age inhibitor, a colorant (such as a pigment or a dye), a UV absorber, an antioxidant, a chain transfer agent, a plasticizer, a softener, an antistatic agent, a solvent, a conductive fiber, or an oligomer having a weight-average molecular weight (Mw) of from 1,000 to 10,000 to the extent that the object of the invention of the present application is not impaired. Those additives may be used alone or in combination thereof.

(Method of producing Pressure-Sensitive Adhesive Layer)

The pressure-sensitive adhesive layer of the conductive pressure-sensitive adhesive tape is produced through, for example, an applying step and an irradiating step to be described below.

(Applying Step)

The applying step is a step of applying, in a layered manner, a pressure-sensitive adhesive composition obtained by mixing a syrup composition, which contains monomers for forming a pressure-sensitive adhesive polymer and a partial polymer obtained by polymerizing part of the monomers, and which has a viscosity of from 10 Pa·s to 30 Pa·s, a photopolymerization initiator, and conductive particles.

The pressure-sensitive adhesive composition is a solventless type and photocurable, and contains at least the syrup composition, the photopolymerization initiator, and the conductive particles. The syrup composition is a syrupy composition that contains at least the monomers for forming the pressure-sensitive adhesive polymer and the partial polymer obtained by polymerizing part of the monomers, and that has a viscosity regulated to from 10 Pa·s to 30 Pa·s.

The syrup composition is formed of a liquid monomer composition obtained by mixing the monomers for forming the pressure-sensitive adhesive polymer and a polymerization initiator, in which part of the monomers are polymerized by utilizing the polymerization initiator so that a viscosity of from 10 Pa·s to 30 Pa·s may be obtained. In other words, the syrup composition contains in itself unreacted monomers for forming the pressure-sensitive adhesive polymer and the partial polymer obtained by polymerizing part of the monomers.

A known or commonly used polymerization method may be used in the polymerization of the partial polymer. For example, the polymerization may be performed by utilizing a thermal polymerization initiator, or the monomers in the monomer composition may be appropriately polymerized by utilizing the above-mentioned photopolymerization initiator. However, the photopolymerization initiator is preferably used in the polymerization of the partial polymer from, for example, the viewpoint that the viscosity of the syrup composition (monomer composition) is easily regulated within the predetermined range.

When the photopolymerization initiator is used, the syrup composition is formed of a composition obtained by irradiating a liquid monomer composition, which is obtained by mixing the monomers for forming the pressure-sensitive adhesive polymer and the photopolymerization initiator, with an active energy ray (e.g., UV light) to polymerize part of the monomers in the monomer composition so that a viscosity of from 10 Pa·s to 30 Pa·s may be obtained.

When the monomer composition is irradiated with the active energy ray, such as UV light, the photopolymerization initiator is activated by the active energy ray to generate a radical, and part of the monomers in the monomer composition are polymerized by the radical. Thus, the partial polymer serving as one kind of pressure-sensitive adhesive polymer is produced in the monomer composition. The viscosity of the syrup composition may be set within the above-mentioned range of from 10 Pa·s to 30 Pa·s by appropriately regulating the irradiance and the like of the active energy ray (e.g., UV light) with which the monomer composition is irradiated to change the weight-average molecular weight and the like of the partial polymer to be produced.

When the viscosity of the syrup composition is 10 Pa·s or more and 30 Pa·s or less, the applicability (workability) of the pressure-sensitive adhesive composition is easily secured, and the thickness of each surface layer of the pressure-sensitive adhesive layer is easily regulated within a predetermined range.

The polymerization rate of the partial polymer is regulated to, for example, preferably 5 mass % or more, more preferably 7 mass % or more, and preferably 15 mass % or less, more preferably 10 mass % or less. The polymerization rate of the partial polymer may be appropriately regulated by, for example, grasping a correlation between the viscosity of the monomer composition and the polymerization rate of the partial polymer in advance, and regulating the viscosity of the monomer composition on the basis of the correlation.

The pressure-sensitive adhesive composition for forming the pressure-sensitive adhesive layer is obtained by adding the conductive particles and the like to the syrup composition whose viscosity has been regulated within the above-mentioned predetermined range. A photopolymerization initiator in the pressure-sensitive adhesive composition may be the photopolymerization initiator added to the liquid monomer composition at the time of the preparation of the syrup composition, or may be a photopolymerization initiator newly added to the syrup composition.

Part of the monomers for forming the pressure-sensitive adhesive polymer may be added to the syrup composition.

The pressure-sensitive adhesive composition has moderate viscosity and moderate flowability, and hence has satisfactory applicability (workability). In the applying step, the pressure-sensitive adhesive composition is applied onto a support having light permeability, such as a base material or a release liner, in a layered manner. A member of the same kind as that of the support is preferably bonded onto the pressure-sensitive adhesive composition applied in a layered manner. When the member is bonded as described above, for example, the inhibition of a polymerization reaction by oxygen in air at the time of the performance of the irradiating step to be described later is suppressed.

A known or commonly used coating method may be used as a method of applying the pressure-sensitive adhesive composition. For example, a general coater (e.g., a gravure roll coater, a reverse roll coater, a kiss roll coater, a dip roll coater, a bar coater, a knife coater, a spray coater, a comma coater, or a direct coater) or printing method may be used.

(Irradiating Step)

The irradiating step is a step of irradiating both surface sides of the layered pressure-sensitive adhesive composition with an active energy ray to cure the pressure-sensitive adhesive composition to provide the pressure-sensitive adhesive layer.

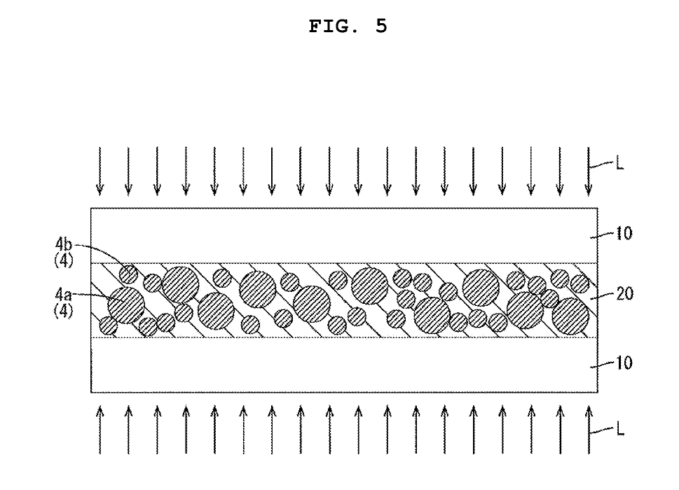

FIG. 5 is an explanatory view for schematically illustrating a step of irradiating both surface sides of a layered pressure-sensitive adhesive composition 20 with UV light L to cure the pressure-sensitive adhesive composition 20. In FIG. 5, the layered pressure-sensitive adhesive composition 20 is in a state in which transparent release liners 10, 10 serving as supports are bonded to both surface sides thereof. Both surface sides of the pressure-sensitive adhesive composition 20 in such state are each irradiated with the UV light L at a predetermined irradiance through the release liner 10. When both surface sides of the pressure-sensitive adhesive composition 20 are irradiated with the UV light L as described above, a photopolymerization initiator in the pressure-sensitive adhesive composition 20 is activated to generate a radical, and hence monomers present in the pressure-sensitive adhesive composition 20 are polymerized to form a pressure-sensitive adhesive polymer. Then, the layered pressure-sensitive adhesive composition 20 is cured along with the formation of the pressure-sensitive adhesive polymer, and hence the pressure-sensitive adhesive layer 2 including the surface layers 22, 22, and the main body layer 21 as illustrated in FIG. 1 is obtained.

The irradiance of the active energy ray, such as UV light, is preferably 1 mW/cm² or more, more preferably 2 mW/cm² or more, and is preferably 10 mW/cm² or less, more preferably 5 mW/cm² or less. When the irradiance falls within such range, the pressure-sensitive adhesive composition can be sufficiently cured, and the thickness of each surface layer of the pressure-sensitive adhesive layer is easily regulated within a predetermined range.

The irradiating step is preferably performed under a nitrogen atmosphere so that the polymerization reaction may not be inhibited by oxygen in air. A drying step may be performed before or after the irradiating step as required.

When the pressure-sensitive adhesive composition is cured through such applying step and irradiating step as described above, the pressure-sensitive adhesive layer that may be utilized in the conductive pressure-sensitive adhesive tape of this embodiment is obtained.

(Thickness of Pressure-Sensitive Adhesive Layer)

Although the thickness (μm) of the pressure-sensitive adhesive layer is not particularly limited as long as the object of the present invention is not impaired, for example, the thickness is preferably 5 μm or more, more preferably 10 μm or more, still more preferably 20 μm or more, particularly preferably 50 μm or more and is preferably 250 μm or less, more preferably 200 μm or less, still more preferably 100 μm or less. When the thickness (μm) of the pressure-sensitive adhesive layer falls within such range, a sufficient pressure-sensitive adhesive strength and sufficient conductivity are easily secured.

The thickness (total thickness) of the pressure-sensitive adhesive layer is measured by a method to be described later.

When the pressure-sensitive adhesive tape includes two pressure-sensitive adhesive layers, the thicknesses of the layers maybe identical to each other, or may be different from each other.

(Thickness of Surface Layer)

The thickness of each surface layer (skin layer) of the pressure-sensitive adhesive layer is 0.1 μm or more, preferably 0.2 μm or more, more preferably 0.3 μm or more, and is 0.9 μm or less, preferably 0.85 μm or less, more preferably 0.8 μm or less. The thickness of the surface layer may be appropriately regulated by setting, for example, the volume fraction (vol %) of the conductive particles to be blended into the pressure-sensitive adhesive layer, the viscosity (Pa·s) of the syrup composition to be utilized in the pressure-sensitive adhesive composition for forming the pressure-sensitive adhesive layer, the thickness (μm) of the pressure-sensitive adhesive layer, and the irradiance (mW/cm²) of the active energy ray (e.g., UV light) with which the pressure-sensitive adhesive composition is irradiated at the time of its curing (at the time of the irradiating step) within the above-mentioned respective predetermined ranges.

When the thickness of each surface layer is set within the above-mentioned range, a sufficient adhesive strength of the pressure-sensitive adhesive layer (conductive pressure-sensitive adhesive tape) to an adherend is secured, and the reworking property of the pressure-sensitive adhesive layer (conductive pressure-sensitive adhesive tape) is secured. The pressure-sensitive adhesive layer whose surface layers each have a thickness set within the above-mentioned range can be peeled from the surface of the adherend without the occurrence of the cohesive failure and the like of the pressure-sensitive adhesive layer. Accordingly, when the pressure-sensitive adhesive layer is peeled, a fragment of the pressure-sensitive adhesive layer is prevented from remaining on the surface of the adherend. In addition, the pressure-sensitive adhesive layer (conductive pressure-sensitive adhesive tape) that has been peeled from the adherend once can be bonded to the adherend again without the impairment of its conductivity and the like.

The thickness of each surface layer of the pressure-sensitive adhesive layer is measured and defined by a method to be described later.

(Base Material)

A base material is a member configured to support the pressure-sensitive adhesive layer, and is not particularly limited. The base material is appropriately selected from known base materials in accordance with purposes. The base material is, for example, a conductive base material having conductivity.

The conductive base material includes a thin base material having conductivity, such as a metal foil. The conductive base material is not particularly limited as long as the base material can support the pressure-sensitive adhesive layer and has conductivity, and the base material is appropriately selected in accordance with purposes. The conductive base material is preferably the metal foil. Examples of materials for the metal foil to be utilized as the conductive base material include copper, aluminum, nickel, silver, iron, lead, and an alloy thereof. Of those, an aluminum foil or a copper foil is preferred, and a copper foil is more preferred, from the viewpoints of, for example, conductivity, processability, and cost. The metal foil may be subjected to various surface treatments, such as tin plating, silver plating, and gold plating. The metal foil is preferably a copper foil (tin-coated copper foil) having applied thereto a coating by tin plating because of, for example, the following reason: the tin-coated copper foil suppresses a reduction in conductivity, an unsatisfactory external appearance, and the like due to corrosion.

A base material except the conductive base material may be utilized as the base material, and for example, a plastic base material, a nonwoven fabric, a woven fabric, a mesh, or a foam base material may be utilized. The surface of the base material may be subjected to various surface treatments, such as embossing.

Although the thickness of the base material is not particularly limited, for example, the thickness is preferably 5 μm or more, more preferably 8 μm or more, still more preferably 10 μm or more, and is preferably 200 μm or less, more preferably 150 μm or less, still more preferably 100 μm or less. When the thickness of the base material falls within such range, the strength of the conductive pressure-sensitive adhesive tape is sufficiently secured, and hence workability at the time of its processing, bonding, or the like is improved.

(Release Liner)

The conductive pressure-sensitive adhesive tape may include a release liner for protecting a pressure-sensitive adhesive surface (surface of the surface layer) of each pressure-sensitive adhesive layer until the time of its use. Such release liner is not particularly limited, and a release liner appropriately selected from known release liners may be used.

Examples of the release liner include: a base material including a release layer, such as a plastic film or paper, having a surface treated with a release agent based on, for example, a silicone, a long chain alkyl, fluorine, or molybdenum sulfide; a low adhesive base material formed of a fluorine-based polymer, such as polytetrafluoroethylene, polychlorotrifluoroethylene, polyvinyl fluoride, polyvinylidene fluoride, a tetrafluoroethylene-hexafluoropropylene copolymer, or a chlorofluoroethylene-vinylidene fluoride copolymer; and a low adhesive base material formed of a non-polar polymer, such as an olefin-based resin (e.g., polyethylene or polypropylene).

When the release liner is used as a support configured to support the pressure-sensitive adhesive composition at the time of the production of the pressure-sensitive adhesive layer, the release liner is preferably excellent in light permeability.

Although the thickness of the release liner is not particularly limited, for example, the thickness is preferably 5 μm or more, more preferably 8 μm or more, still more preferably 10 μm or more, and is preferably 200 μm or less, more preferably 150 μμm or less, still more preferably 100 μm or less.

(Pressure-Sensitive Adhesive Strength)

In the conductive pressure-sensitive adhesive tape, the pressure-sensitive adhesive strength (N/25 mm) of the pressure-sensitive adhesive layer is preferably 8 N/25 mm or more, more preferably 10 N/25 mm or more, and is preferably 25 N/25 mm or less. In particular, the pressure-sensitive adhesive strength (N/25 mm) of the pressure-sensitive adhesive layer after the layer has been left to stand for 1 day (at a temperature of 23° C. and a humidity of 50%RH) in a state of being bonded to an adherend is preferably 25 N/25 mm or less. When the pressure-sensitive adhesive strength of the pressure-sensitive adhesive layer falls within such range, the pressure-sensitive adhesive layer can be brought into close contact with the adherend, and the reworking property of the pressure-sensitive adhesive layer is easily secured. The pressure-sensitive adhesive strengths (30 minutes after and 1 day after) of the pressure-sensitive adhesive layer are measured by a 180° peel test in conformity with JIS Z 0237 to be described later.

(Reworking Property)

The conductive pressure-sensitive adhesive tape is required to have a reworking property intended for the recovery of an adherend, such as a substrate or an electronic part. When actual work is imagined, the following reworking property is required: even after a lapse of 1 day from the bonding of the tape, the factor by which the pressure-sensitive adhesive strength of the tape increases relative to the pressure-sensitive adhesive strength thereof 30 minutes after the bonding is 2 or less, and the tape does not undergo any cohesive failure and hence no adhesive residue is present on the adherend.

(Conductivity)

In the conductive pressure-sensitive adhesive tape, the pressure-sensitive adhesive layer has a resistance value in a Z-axis direction (thickness direction) of, for example, preferably 70 mΩ or less, more preferably 60 mΩ or less, still more preferably 50 mΩ or less . A method of measuring the resistance value in the Z-axis direction (thickness direction) of the pressure-sensitive adhesive layer is described later.

(Applications)

The conductive pressure-sensitive adhesive tape can be used in grounding (earthing) applications, such as the grounding of a printed wiring board, the grounding of the outer package shield case of electronic equipment, and grounding for static protection. In addition, the conductive pressure-sensitive adhesive tape can also be used in applications such as the internal wiring of, for example, a power supply apparatus or electronic equipment (e.g., a portable information terminal, a display apparatus, such as a liquid crystal display apparatus, an organic electroluminescence (EL) display apparatus, a plasma display panel (PDP), or electronic paper, or a solar cell). In addition, the conductive pressure-sensitive adhesive tape can also be used in, for example, an application where two sites distant from each other are electrically connected, and electromagnetic shielding applications for electrical and electronic equipment, and cables.

In addition, the conductive pressure-sensitive adhesive tape can be suitably used in, for example, small electronic and electrical equipment (e.g., a portable information terminal, a smart phone, a tablet terminal, a cellular phone, or a car navigation system). In addition, the conductive pressure-sensitive adhesive tape can be utilized in an electronic member. Examples of the electronic member include a wiring board (e.g., a FPC or a rigid circuit board), a camera, a CPU, a driver circuit, an antenna, and a reinforcing plate for a wiring board.

(1) A conductive pressure-sensitive adhesive tape, including a pressure-sensitive adhesive layer containing a pressure-sensitive adhesive resin containing a pressure-sensitive adhesive polymer and conductive particles dispersed in the pressure-sensitive adhesive resin, in which: the pressure-sensitive adhesive layer has a surface layer that is formed of the pressure-sensitive adhesive resin and that forms a surface of the pressure-sensitive adhesive layer; and a thickness of the surface layer, which is defined as an analysis depth from the surface of the pressure-sensitive adhesive layer when a spectral intensity derived from the conductive particles in glow discharge spectrometry becomes one half of a maximum thereof, is 0.1 μm or more and 0.9 μm or less.

(2) The conductive pressure-sensitive adhesive tape according to Item (1), in which the pressure-sensitive adhesive layer has a thickness of 5 μm or more and 250 μm or less.

(3) The conductive pressure-sensitive adhesive tape according to Item (1) or (2), in which a volume fraction (vol %) of the conductive particles in the pressure-sensitive adhesive layer is from 10 vol % to 50 vol %.

(4) The conductive pressure-sensitive adhesive tape according to any one of Items (1) to (3), in which the conductive particles have an average particle diameter of 1 μm or more and 50 μm or less.

(5) The conductive pressure-sensitive adhesive tape according to any one of Items (1) to (4), in which the pressure-sensitive adhesive polymer includes an acrylic polymer.

(6) The conductive pressure-sensitive adhesive tape according to Item (5), in which the acrylic polymer contains a constituent unit derived from a (meth)acrylic acid alkyl ester having a linear or branched alkyl group having 1 to 20 carbon atoms.

(7) The conductive pressure-sensitive adhesive tape according to Item (5) or (6), in which the acrylic polymer contains a constituent unit derived from a polar group-containing monomer.

(8) The conductive pressure-sensitive adhesive tape according to Item (7), in which the polar group-containing monomer includes a carboxyl group-containing monomer.

(9) The conductive pressure-sensitive adhesive tape according to Item (7), in which the polar group-containing monomer includes a heterocyclic ring-containing vinyl-based monomer.

(10) The conductive pressure-sensitive adhesive tape according to any one of Items (5) to (9), in which the acrylic polymer contains a constituent unit derived from a polyfunctional monomer.

(11) The conductive pressure-sensitive adhesive tape according to any one of Items (1) to (10), in which the conductive particles each have a core particle and a metal layer configured to cover the core particle.

(12) The conductive pressure-sensitive adhesive tape according to Item (11), in which the metal layer of each of the conductive particles includes any one of Ag, Ni, Cu, and Au.

(13) The conductive pressure-sensitive adhesive tape according to Item (11) or (12), in which the core particle of each of the conductive particles includes any one of a polymer resin, glass, metal, and ceramic.

(14) The conductive pressure-sensitive adhesive tape according to any one of Items (1) to (13), in which the surface layer is integrally formed on each of both surfaces of a main body layer arranged on a center side of the pressure-sensitive adhesive layer.

(15) A method of producing the conductive pressure-sensitive adhesive tape of any one of Items (1) to (14), the method including: applying, in a layered manner, a pressure-sensitive adhesive composition obtained by mixing a syrup composition, which contains monomers for forming the pressure-sensitive adhesive polymer and a partial polymer obtained by polymerizing part of the monomers, and which has a viscosity of from 10 Pa·s to 30 Pa·s, a photopolymerization initiator, and the conductive particles; and irradiating both surface sides of the layered pressure-sensitive adhesive composition with an active energy ray to cure the pressure-sensitive adhesive composition to provide a pressure-sensitive adhesive layer.

(16) The method of producing the conductive pressure-sensitive adhesive tape according to Item (15), in which in the irradiating step, the active energy ray is formed of UV light and the active energy ray has an irradiance of from 1 mW/cm² to 10 mW/cm².

The present invention is described in more detail below by way of Examples. The present invention is by no means limited by these Examples.

### EXAMPLE 1

### (Production of Syrup Composition a1)

A liquid monomer composition obtained by mixing 84 parts by mass of 2-ethylhexyl acrylate (2EHA) and 16 parts by mass of N-vinyl-2-pyrrolidone (NVP) was blended with 0.05 part by mass of a photopolymerization initiator available under the product name “IRGACURE 651 (2,2-dimethoxy-1,2-diphenylethan-1-one)” (manufactured by BASF Japan Ltd.) and 0.05 part by mass of a photopolymerization initiator available under the product name “IRGACURE 184 (1-hydroxycyclohexyl phenyl ketone)” (manufactured by BASF Japan Ltd.). After that, the resultant was irradiated with UV light (irradiance: 2 mW/cm²) until its viscosity (viscometer: manufactured by TOKIMEC, VISCOMETER (model: B H)) became 14.7 Pa·s. Thus, a syrup composition al containing a partial polymer obtained by the polymerization of part of the monomer components through the irradiation was obtained.

(Production of Pressure-Sensitive Adhesive Composition)

The syrup composition al was blended with 3 parts by mass of acrylic acid (AA), 0.05 part by mass of 1,6-hexanediol diacrylate (HDDA), 150 parts by mass of conductive particles (product name: “TP25S12”, manufactured by Potters-Ballotini Co., Ltd., silver-coated glass powder, particle diameter corresponding to the peak top of a particle size distribution curve: 26 μm, particle diameter range: 18 μm to 35 μm, true density: 2.7 g/cm³), 50 parts by mass of conductive particles (product name: “ES-6000-S7N”, manufactured by Potters-Ballotini Co., Ltd., silver-coated glass powder, particle diameter corresponding to the peak top of a particle size distribution curve: 6 μm, particle diameter range: 2 μm to 10 μm, true density: 3.9 g/cm³), and 0.05 parts by mass of a photopolymerization initiator available under the product name “IRGACURE 651 (2,2-dimethoxy-1,2-diphenylethan-1-one)” (manufactured by BASF Japan Ltd.), and the syrup composition al and the foregoing materials were sufficiently mixed to provide a pressure-sensitive adhesive composition A1.

(Production of Pressure-Sensitive Adhesive Tape)

The pressure-sensitive adhesive composition A1 was applied onto the release-treated surface of a transparent release liner to form an applied layer on the release liner. Then, another transparent release liner was bonded onto the applied layer so that its release-treated surface was brought into contact therewith. Thus, the release liners were bonded to each other so that the applied layer was sandwiched therebetween. Polyethylene terephthalate base materials (product name: “MRE”, thickness: 38 μm, manufactured by Mitsubishi Polyester Film Inc.; product name: “MRF”, thickness: 38 μm, manufactured by Mitsubishi Polyester Film Inc.) having the following feature were used as the release liners: one surface of each of the base materials was subjected to a release treatment.

Next, the applied layer was cured by irradiating both surfaces of the applied layer with UV light having an irradiance of 2 mW/cm² for 3 minutes. Thus, a pressure-sensitive adhesive layer having the following features was obtained: the thickness of each surface layer (skin layer) of the pressure-sensitive adhesive layer was 0.8 μm, the total thickness of the layer was 50 μm, and the volume fraction (vol %) of the conductive particles in the layer was 40 vol % . “BLACK LIGHT” manufactured by Toshiba Corporation was used as the emission source of the UV light. In addition, the irradiance of the UV light was regulated with a UV checker (product name : “UVR-T1”, manufactured by Topcon Corporation, maximum sensitivity: measured at 350 nm).

Thus, a pressure-sensitive adhesive tape of Example 1 (base material-less conductive double-sided pressure-sensitive adhesive tape having a laminated structure “release liner/pressure-sensitive adhesive layer/release liner”) was obtained.

(Total Thickness of Pressure-Sensitive Adhesive Layer)

The total thickness of the pressure-sensitive adhesive layer was measured with a dial gauge specified in JIS B 7503. The contact surface of the dial gauge was a flat surface, and its diameter was set to 5 mm. A test piece having a width of 150 mm was used, and thicknesses at five points arranged at equal intervals in its widthwise direction were measured with a dial gauge having a scale of 1/1,000 mm. The average of the measurement results was defined as the total thickness of the pressure-sensitive adhesive layer. The total thicknesses of pressure-sensitive adhesive layers in the subsequent Examples and Comparative Examples were similarly determined.

(Thickness of Surface Layer of Pressure-sensitive Adhesive Layer)

In addition, the thickness of a surface layer (skin layer) of the pressure-sensitive adhesive layer was determined by the following method. The thicknesses of the surface layers of the pressure-sensitive adhesive layers in the subsequent Examples and Comparative Examples were similarly measured.

First, a sample having a predetermined size was cut out of the resultant pressure-sensitive adhesive tape. Then, one release liner was removed from the pressure-sensitive adhesive tape (sample) so that one pressure-sensitive adhesive surface was exposed, and the pressure-sensitive adhesive surface was made tackless (non-pressure-sensitive adhesive) by irradiating the pressure-sensitive adhesive surface with an X-ray. An apparatus for XRF (product name: “ZSX-100E”, manufactured by Rigaku Corporation) was utilized in a treatment (tackless treatment) in which the pressure-sensitive adhesive surface was irradiated with the X-ray. Treatment conditions were as follows: the voltage and current of the X-ray were 50 kV and 70 mA, respectively, and the time period for which the surface was irradiated with the X-ray was 240 seconds.

Subsequently, the pressure-sensitive adhesive surface that had been made tackless was analyzed for the abundance ratio of the conductive particles (filler) in a thickness direction (depth direction) of the pressure-sensitive adhesive layer by utilizing a glow discharge optical emission spectrometer (GD-OES, product name: “GD-Profiler 2”, manufactured by HORIBA, Ltd.). Conditions for the analysis with the glow discharge optical emission spectrometer were as follows: a sputtering pressure was 600 Pa, a sputtering applied voltage was 35 W, a set mode was a pulse mode, a frequency was 50 Hz, a duty cycle was 0.1, and a measurement time was 600 seconds. In addition, an etching depth measured with a step gauge (product name: “SURFCORDER SE300”, manufactured by Kosaka Laboratory Ltd.) was utilized in the calculation of the etching rate of the analyzed sample (pressure-sensitive adhesive tape). The thickness of the surface layer (skin layer) in the pressure-sensitive adhesive tape (sample) was defined as an analysis depth from the surface of the pressure-sensitive adhesive layer when a spectral intensity (in this case, the spectral intensity of Ag) derived from the conductive particles (filler) in glow discharge spectrometry (GDS) became one half (½) of the maximum (spectral peak top) thereof.

(Volume Fraction of Conductive Particles)

The volume fraction of the conductive particles in the pressure-sensitive adhesive layer was measured by the following method. The volume fractions of the conductive particles in the pressure-sensitive adhesive layers in the subsequent Examples and Comparative Examples were similarly determined.

First, a sample having a predetermined size was cut out of each of the resultant pressure-sensitive adhesive tapes. The sample was subjected to FIB processing with a FIB-SEM apparatus (focused ion beam-scanning electron microscope) and a SEM image of a processed section thereof was taken with the apparatus; the procedure was repeated a plurality of times. Thus, a continuous sectional SEM image was obtained. Then, a three-dimensional reconstructed image (corresponding to a space measuring 83 μm wide by 64 μm long by 40 μm thick) was obtained from the connuous sectional SEM image by utilizing analysis software attached to the apparatus. After that, the three-dimensional reconstructed image was subjected to binarization processing into a filler and a parent material portion by utilizing image analysis software “Amira” (manufactured by Mercury Computer Systems), and then quantitative analysis was performed to calculate the volume fraction (vol %) of the filler in the sample (pressure-sensitive adhesive layer). An apparatus available under the product name “Helios Nanolab 600” (manufactured by FEI) was used as the FIB-SEM apparatus. In addition, the acceleration voltage of the FIB was set to 30 kV, and the acceleration voltage of the SEM was set to 1 kV.

### EXAMPLES 2 TO 4 AND COMPARATIVE EXAMPLES 1 TO 3

Syrup compositions of Examples 2 to 4 and Comparative Examples 1 to 3 each containing a partial polymer obtained by polymerizing part of the monomers were each obtained in the same manner as in Example 1 except that the monomer composition was irradiated with UV light (irradiance: 2 mW/cm²) so that its viscosity (Pa·s) became each value shown in Table 1. Then, pressure-sensitive adhesive tapes of Examples 2 to 4 and Comparative Examples 1 to 3 were obtained through the utilization of the syrup compositions of Examples 2 to 4 and Comparative Examples 1 to 3 by the same method as that of Example 1. In addition, the thicknesses of the surface layers of the pressure-sensitive adhesive tapes of Examples 2 to 4 and Comparative Examples 1 to 3 were measured in the same manner as in Example 1. The measurement results are shown in Table 1.

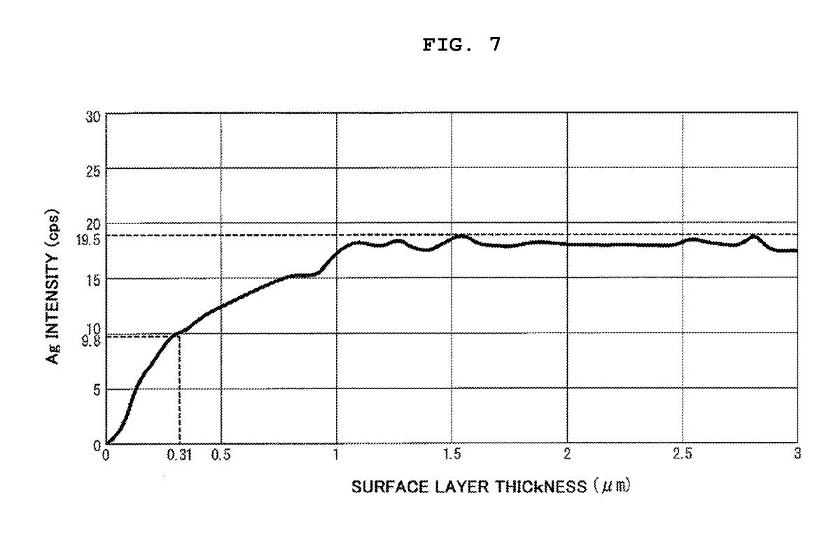

Here, the thickness (μm) of a surface layer determined by GDS is described by taking Example 4 as an example. FIG. 7 is a graph for showing a relationship obtained by the GDS between a Ag spectral intensity (cps) and an analysis depth (μm) in the pressure-sensitive adhesive tape (pressure-sensitive adhesive layer) of Example 4. The axis of abscissa of the graph shown in FIG. 7 indicates the analysis depth (μm) of the pressure-sensitive adhesive layer of Example 4 obtained by the GDS, and the axis of ordinate thereof indicates the Ag spectral intensity (cps) derived from the conductive particles in the pressure-sensitive adhesive layer of Example 4. As shown in FIG. 7, the peak top of the Ag spectral intensity was 19.5 cps, and an analysis depth when the intensity became one half of the peak top, i.e., 9.8 cps was 0.31 μm.

[Evaluation]

The pressure-sensitive adhesive strength (30 minutes after), pressure-sensitive adhesive strength (1 day after), and resistance value (Z-axis direction) of each of the pressure-sensitive adhesive tapes of Examples and Comparative Examples were measured by the following methods.

(Pressure-sensitive Adhesive Strength (30 Minutes after))

A measurement sample measuring 25 mm wide by 100 mm long was cut out of each of the resultant pressure-sensitive adhesive tapes. One pressure-sensitive adhesive surface of the pressure-sensitive adhesive layer of the sample was bonded to a SUS plate (SUS304 plate) by reciprocating a roller having a weight of 2.0 kg and a width of 30 mm once under an atmosphere at 23° C. and 50% RH. The other pressure-sensitive adhesive surface of the pressure-sensitive adhesive layer is in a state in which the release liner remains bonded thereto. After the resultant had been left to stand at normal temperature (23° C., 50% RH) for 30 minutes, a 180° peel test was performed with a tensile tester in conformity with JIS Z 0237 at a tensile rate of 300 mm/min to measure a peel pressure-sensitive adhesive strength (N/25 mm). The results are shown in Table 1.

(Pressure-Sensitive Adhesive Strength (1 Day after))

The peeling pressure-sensitive adhesive strength (N/25 mm) of each of the pressure-sensitive adhesive tapes was measured in the same manner as in the above-mentioned pressure-sensitive adhesive strength measurement except that the time period for which the tape was left to stand was changed to 1 day (24 hours). The results are shown in Table 1.

(Resistance Value (Z-axis Direction))

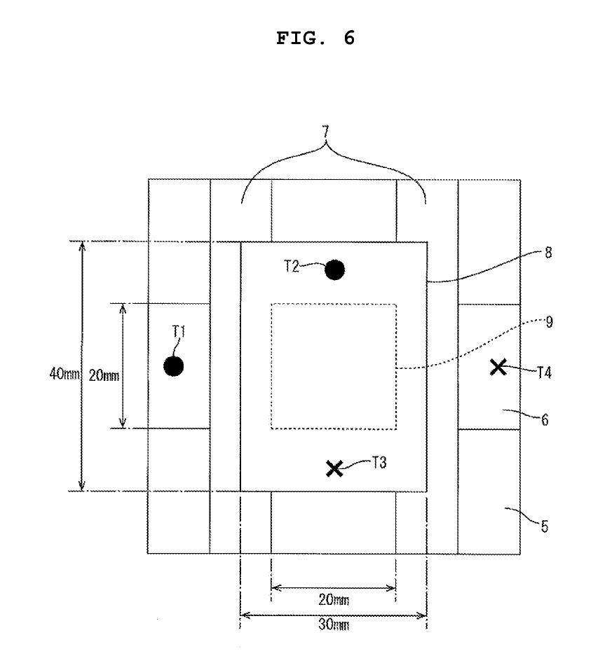

A copper foil (rolled copper foil, thickness : 35 μm) was bonded to each of the resultant pressure-sensitive adhesive tapes, and then a measurement sample measuring 30 mm wide by 40 mm long was cut out of the resultant. According to dimensions illustrated in FIG. 6, a copper foil (rolled copper foil, thickness: 35 μm) 6 was placed on a glass plate (soda lime glass) 5, insulating tapes 7 were superimposed on the copper foil 6, and the copper foil 6 and a measurement sample 8 were crimped with each other under a normal-temperature environment with a hand roller (width: 30 mm) at a pressure of 5.0 N/cm² so that the area of a bonding portion 9 (the inside of a region surrounded by broken lines in FIG. 6) became 4 cm². A longitudinal direction of FIG. 6 is a lengthwise direction of the measurement sample 8, and the sample was bonded so that a pressure-sensitive adhesive surface of the pressure-sensitive adhesive layer of the pressure-sensitive adhesive tape was brought into contact with the surface of the copper foil 6. After the bonding, the resultant was left to stand under a normal-temperature environment for 15 minutes, and then the terminals of a resistance meter (RM3544-01 manufactured by Hioki E.E. Corporation) were connected to the end portions of the copper foil (portions corresponding to marks represented by symbols T1 and T2 in FIG. 6) to measure the resistance value of the pressure-sensitive adhesive tape (pressure-sensitive adhesive layer) in its thickness direction (Z-axis direction). The results are shown in Table 1.

TABLE 1

| | Pressure-sensitive adhesive layer | | | | | | | |
|---|---|---|---|---|---|---|---|---|
| | Thickness | | Volume | UV | | | | Resistance |
| | of | | fraction of | irradiance | Viscosity | Pressure-sensitive | Pressure-sensitive | value |
| | surface | Total | conductive | at time of | of syrup | adhesive strength | adhesive strength | (Z-axis |
| | layer | thickness | particles | curing | composition | (30 minutes after) | (1 day after) | direction) |
| | (μm) | (μm) | (vol %) | (mW/cm²) | (Pa · s) | (N/25 mm) | (N/25 mm) | (mΩ) |
| Example 1 | 0.8 | 50 | 40 | 2 | 14.7 | 12.8 | 20.0 | 45 |
| Example 2 | 0.53 | 50 | 40 | 2 | 17.8 | 11.8 | 18.1 | 30 |
| Example 3 | 0.46 | 50 | 40 | 2 | 21.2 | 10.4 | 16.9 | 14 |
| Example 4 | 0.31 | 50 | 40 | 2 | 28.2 | 10.2 | 15.1 | 5.5 |
| Comparative | 3.42 | 50 | 40 | 2 | 4.1 | >30 | >30 | 199 |
| Example 1 | | | | | | (Cohesive failure) | (Cohesive failure) | |
| Comparative | 1.3 | 50 | 40 | 2 | 7.6 | 12.2 | >30 | 94 |
| Example 2 | | | | | | | (Cohesive failure) | |
| Comparative | 0.08 | 50 | 40 | 2 | 37.5 | 1.43 | 3.1 | 5 |
| Example 3 | | | | | | | | |

As shown in Table 1, each of the conductive pressure-sensitive adhesive tapes of Examples 1 to 4 has a resistance value (Z-axis direction) of 45 mΩ or less, and is hence excellent in conductivity. In addition, each of the conductive pressure-sensitive adhesive tapes of Examples 1 to 4 has pressure-sensitive adhesive strengths (30 minutes after and 1 day after) of 10 N/25 mm or more, i.e., has sufficient pressure-sensitive adhesive strengths. Moreover, it was confirmed that each of the conductive pressure-sensitive adhesive tapes of Examples 1 to 4 had a pressure-sensitive adhesive strength (1 day after) of 20 N/25 mm or less, and was hence excellent in reworking property. In each of the conductive pressure-sensitive adhesive tapes of Examples 1 to 3, peeling occurred at an interface between the pressure-sensitive adhesive surface (surface of the surface layer) of the pressure-sensitive adhesive layer and the surface of the adherend.

In contrast, each of the pressure-sensitive adhesive strengths (30 minutes after and 1 day after) of the conductive pressure-sensitive adhesive tape of Comparative Example 1 to the adherend took a value of more than 30 N/25 mm because the thickness of the surface layer was much larger than those of Examples. Moreover, in Comparative Example 1, failure occurred (so-called cohesive failure occurred) inside the pressure-sensitive adhesive layer at the time of the peeling of the conductive pressure-sensitive adhesive tape. In addition, it was confirmed that the conductive pressure-sensitive adhesive tape of Comparative Example 1 had so large a thickness of the surface layer that its resistance value (Z-axis direction) became 199 mΩ and hence its conductivity was not sufficient.

It was confirmed that because the thickness of the surface layer of the conductive pressure-sensitive adhesive tape of Comparative Example 2 was larger than those of Examples, the resistance value (Z-axis direction) of the tape became 94 mΩ and hence the conductivity thereof was not sufficient. After the tape had been left to stand for 1 day, its pressure-sensitive adhesive strength took a value of more than 30 N/25 mm, and moreover, failure occurred (so-called cohesive failure occurred) inside the pressure-sensitive adhesive layer.

The conductive pressure-sensitive adhesive tape of Comparative Example 3 provided the following results because the thickness of the surface layer was smaller than those of Examples: sufficient pressure-sensitive adhesive strengths (30 minutes after and 1 day after) were not obtained. The result of the conductivity of the tape was as follows: the resistance value thereof was 5 mΩ or less.

(Relationship Between Viscosity of Syrup Composition and Thickness of Surface Layer)

When the viscosity of the syrup composition is excessively high (Comparative Example 3), the dispersibility of the conductive particles in the pressure-sensitive adhesive layer reduces, and hence the thickness of the surface layer (skin layer) becomes smaller. In contrast, when the viscosity of the syrup composition is excessively low (Comparative Example 1 or 2), the dispersibility of the conductive particles in the pressure-sensitive adhesive layer is raised, and hence the thickness of the surface layer (skin layer) becomes larger.

What is claimed is:

1. A conductive pressure-sensitive adhesive tape, comprising a pressure-sensitive adhesive layer containing a pressure-sensitive adhesive resin containing a pressure-sensitive adhesive polymer and conductive particles dispersed in the pressure-sensitive adhesive resin, wherein:
the pressure-sensitive adhesive layer has a surface layer that is formed of the pressure-sensitive adhesive resin and that forms a surface of the pressure-sensitive adhesive layer; and
a thickness of the surface layer, which is defined as an analysis depth from the surface of the pressure-sensitive adhesive layer when a spectral intensity derived from the conductive particles in glow discharge spectrometry becomes one half of a maximum thereof, is 0.1 μm or more and 0.9 μm or less.

2. The conductive pressure-sensitive adhesive tape according to claim 1, wherein the pressure-sensitive adhesive layer has a thickness of 5 μm or more and 250 μm or less.

3. The conductive pressure-sensitive adhesive tape according to claim 1, wherein a volume fraction (vol %) of the conductive particles in the pressure-sensitive adhesive layer is from 10 vol % to 50 vol %.

4. The conductive pressure-sensitive adhesive tape according to claim 1, wherein the conductive particles have an average particle diameter of 1 μm or more and 50 μm or less.

5. The conductive pressure-sensitive adhesive tape according to claim 1, wherein the pressure-sensitive adhesive polymer comprises an acrylic polymer.

6. A method of producing the conductive pressure-sensitive adhesive tape of claim 1, the method comprising:
applying, in a layered manner, a pressure-sensitive adhesive composition obtained by mixing a syrup composition, which contains monomers for forming the pressure-sensitive adhesive polymer and a partial polymer obtained by polymerizing part of the monomers, and which has a viscosity of from 10 Pa·s to 30 Pa·s, a photopolymerization initiator, and the conductive particles; and
irradiating both surface sides of the layered pressure-sensitive adhesive composition with an active energy ray to cure the pressure-sensitive adhesive composition to provide a pressure-sensitive adhesive layer.

7. The method of producing the conductive pressure-sensitive adhesive tape according to claim 6, wherein in the irradiating step, the active energy ray is formed of UV light and the active energy ray has an irradiance of from 1 mW/cm² to 10 mW/cm².
